(19) United States
(12) Patent Application Publication
(10) Pub. No.: US 2005/0253824 A1
(43) Pub. Date: Nov. 17, 2005

(54) [SERIAL-PROTOCOL TYPE PANEL DISPLAY SYSTEM AND METHOD]

(76) Inventor: Che-Li Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,404

(22) Filed: Jul. 8, 2004

(30) Foreign Application Priority Data
May 14, 2004 (TW) 93113595

(51) Int. Cl. G09G 3/36

(52) U.S. Cl. 345/204

(57) ABSTRACT

A serial-protocol type panel display system is suitable for use in a panel display apparatus. The panel display system includes a pixel-array display unit. Multiple divers are used to drive the pixel-array display unit to display an image. A VGA unit uses a serial protocol for encoding and exports a serial image display signal and a clock signal to the drivers. Wherein, the drivers decode the serial image display signal to obtain multiple desired displaying signals to drive the pixels of the pixel-array display unit.

### CROSS REFERENCE TO RELATED APPLICATIONS

This application claims the priority benefit of Taiwan application serial no. 93113595, filed on May 14, 2004.

### BACKGROUND OF INVENTION

1. Field of Invention

The present invention relates to panel display system. More particularly, the present invention relates to a serial-protocol type panel display system.

2. Description of Related Art

In recent years, due to the great development and achievement on image display technology, a large portion of the convention CRT display has been replaced by the so-called panel display apparatus. The panel display, as commonly seen, is the thin-film transistor (TFT) liquid crystal display (LCD). Also, the panel displays made from light-emitting diodes or plasma are gradually in popular.

The display member of the panel display apparatus is composed of a pixel array. The pixel array usually is a matrix array, which is controlled by a driver. The pixels are driven by a driver to display the image information by this manner of point matrix. Due to the control by the driver, the pixels display the desired color at the specific time period.

In the following descriptions, the TFT-LCD panel display apparatus is used as the example for descriptions. In FIG. 1, the LCD apparatus basically includes a TFT-LCD pixel array 120 to display the image. The columns and rows of the pixel array 120 are respectively driven by source drivers 122 and gate drivers 124. The power unit 130 can be DC/DC converter, to provide the operating voltage to the source drivers 122 and the gate drivers 124. In addition, an ASIC (Application Specification IC) chip 126, according to the input information from the connector 128, generates the proper clock and the color information etc., and export the corresponding the needed information signals to the source drivers 122 and the gate drivers 124, as indicated by arrows. The needed information signals are known by the skilled artisans and are not further described.

In general, the ASIC chip 126 includes a receiver 126a, a RSDS/TTL transmitter 126b, and a timing controller 126c. In addition, a gamma color correction unit 132 provides the information of color correction to the source drivers 122.

Further, the conventional source driver 122 is shown in FIG. 2. In FIG. 2, the conventional source driver 122 includes, for example, a shift register, a line latch, a level shift, a digital-to-analog converter (DAC), an output buffer, a signal receiver, and data register. Wherein, the DAC receives, in parallel, the voltage values VGMA1 VGMA14 to define a gamma color correction curve. Signal receiver receives the input signals, such as RSRS related signals. In addition, the output signal Y1, Y2, . . . of the output buffer are used to drive the pixels for display. As shown in FIG. 2, the conventional source driver is known by the skilled artisans, and is not further described.

FIG. 3 is a drawing, schematically illustrating the conventional gate driver 124 (300). In FIG. 3, the gate driver 300 includes the shift register and the level shift to receive several control signals. In addition, the signals X0, X1, . . . output from the level shift together with the signals Y0, Y1, . . . are used to drive the corresponding one of the pixels. The conventional gate driver is also known by the skilled artisan and is not further described.

For the conventional LCD system, the ASIC chip 126 is used to control the drivers. Particularly, it has the problems that the timing controller 126c, the RSDS/TTL transmitter 126b, and the receiver 126a of the ASIC chip 126 certainly consume more system power. Further still, the system information from the connector 128 is transmitted in series. However, the control signals between the timing controller and the drivers are transmitted through the bus in parallel. As the high image resolution is required, the pixel information is in high bit-size (for example, the usual 6-bit size for describing the RGB data is changed to the 10-bit size). In this manner, some other problems about the larger bus being used and the interference between signals, such as EMI, are annoying. Furthermore, the driving circuit board, as shown in FIG. 1, would occupy a larger space. The fabrication cost cannot be reduced. Also and, the input interface also cause other issues and consumes more power source.

### SUMMARY OF INVENTION

The invention provides a serial-protocol type panel display system, wherein the conventional ASIC can be omitted.

The invention provides a serial-protocol type panel display system, suitable for use in a panel display apparatus. The panel display system includes a pixel-array display unit. Several drivers are used to drive pixel-array display unit to display an image. Also and, a video graphic adapter (VGA) unit exports a serial image signals and a timing control signal to the corresponding drivers, according to a serial protocol. Wherein, the drivers decode the serial image signals, so as to obtain multiple desired displaying signals to drive the pixels of the pixel-array display unit.

The invention also provides a source driver, suitable for use in a panel display apparatus to drive corresponding pixels. The source driver includes a source input-interface, to receive a serial image signal and a timing signal, wherein the serial image signals and the timing signal are continuously transmitted to a next source driver and are used to be decoded out the source input signals. A state-in-the-art source driver, respectively receives the source input signals.

The invention also provides a serial-protocol type display method, which includes receiving an image control signal and a timing signal. According to a serial protocol, the image control signal is encoded into a serial image display signal. The serial image display signal and the clock signal are sequentially fed into several first drivers. At least a portion of the serial image display signal and the clock signal are sequentially fed to several second drivers. For each of the first drivers, the serial image display signal is decoded into a first set of control signals and several color information, used on the pixels for display. For each of the second drivers, the serial image display signal is decoded into a second set of control signals. Also and, the first set of control signals, the second set of control signals, and the color information are used to drive the pixels.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram, schematically illustrating a conventional LCD apparatus.

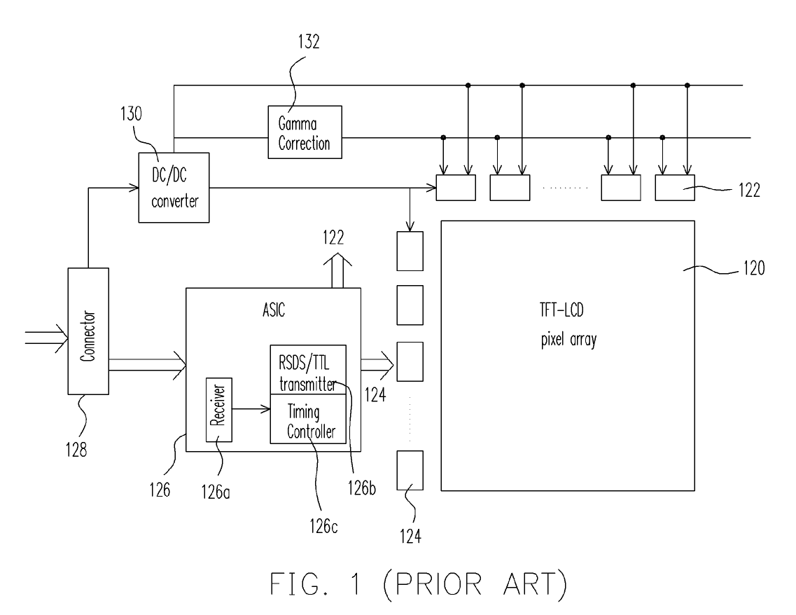

FIG. 2 is a block diagram, schematically illustrating a conventional source driver.

FIG. 3 is a block diagram, schematically illustrating a conventional gate driver.

FIG. 4 is a block diagram, schematically illustrating an LCD apparatus, according to an embodiment of the invention.

FIG. 5 is a block diagram, schematically illustrating a source driver, according to an embodiment of the invention.

FIG. 6 is a block diagram, schematically illustrating a gate driver, according to an embodiment of the invention.

FIG. 7 is a block diagram, schematically illustrating a VGA unit, according to an embodiment of the invention.

### DETAILED DESCRIPTION

The invention uses a serial protocol manner to transmit the system data, which can drive the corresponding pixels after being decoded by the driver, wherein the conventional ASIC chip can be omitted. Further, with respect to the pixel drive, for example, it has been sufficient to only further include a decoder and a switching unit to incorporate with a state-in-the-art driver about input data and control signal. The invention is basically compatible with current LCD system. Manufacturers can easily adapt the technology provided by the invention without need of making much different design.

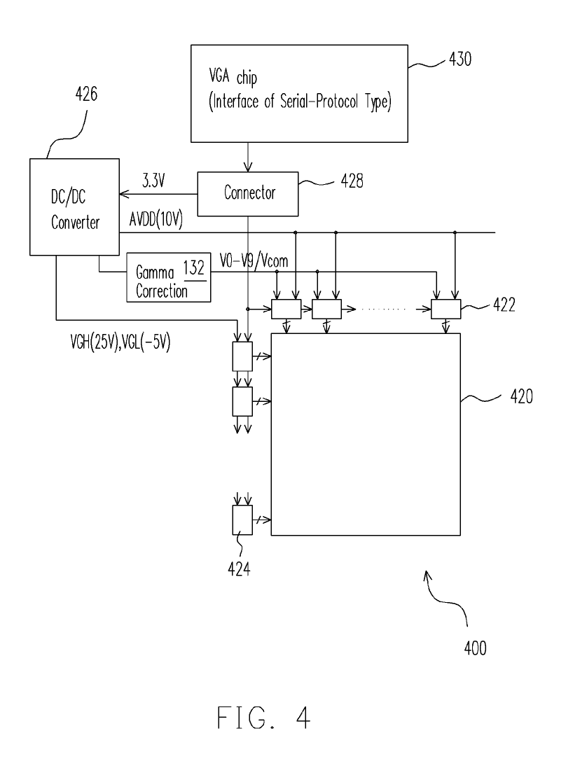

In FIG. 4, it is a block diagram, schematically illustrating an LCD apparatus 400, according to an embodiment of the invention. The LCD apparatus 400 includes a pixel-array unit 420. The pixel-array unit 420 can be a liquid crystal pixel array or other pixel array, such as the pixel array of light emitting diode (LED) or plasma. The liquid crystal pixel array is taken as the example for descriptions.

Several first drivers, such as the source drivers 422, and several second drivers, such as gate drivers 424, are implemented at the peripheral region of the pixel array 420, so as to drive the pixels in 2-dimesional manner for displaying the image. In general, the source drivers 422 are driving the pixels in x direction, and the gate drivers 424 are diving the pixels in y direction. Certainly, the drivers are necessary to receive the input of the corresponding data and control signals, so as to drive the pixels for display. In addition, the DC/DC converter 426 is used to provide the different proper voltage levels to various devices. The gamma correction 132 provides the color management information to the driver. The operation is detail should be known by the ordinary skilled artisans and is not further described.

The invention proposes to use the serial-protocol manner to transmit data, so that the conventional ASIC chip can be omitted. The image data signals from the VGA unit 430 (or called VGA chip 430) are first encoded by a serial protocol, and then are sequentially fed to those two types of drivers 422, 424. After the drivers 422, 424 receives the image information, the corresponding information needed by the drivers is decoded out, and the input is also sequentially passed to the next driver. Since the source driver 422 and the gate driver 424 are designed to have different functions, the information needed by the drivers is different. However, since the needed information is encoded into the image data signals, the individual driver can decode out what it needs.

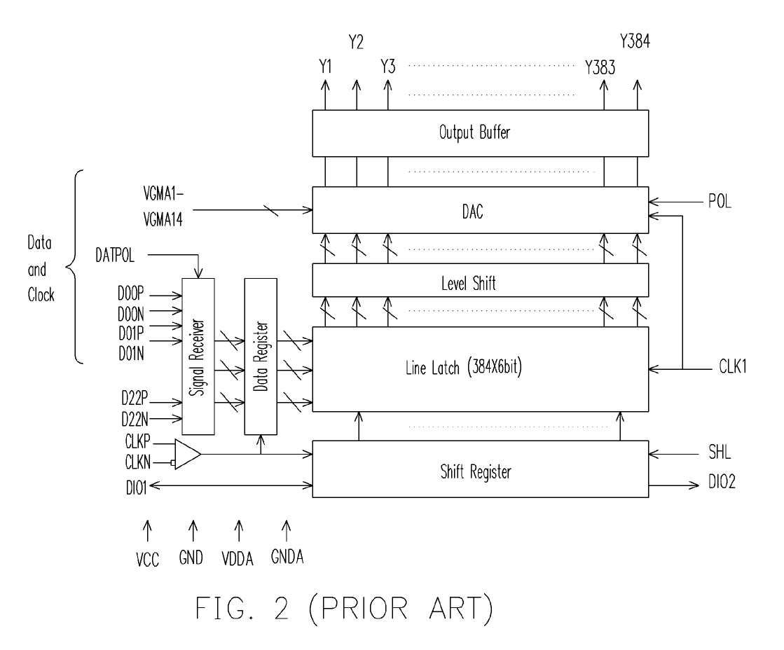

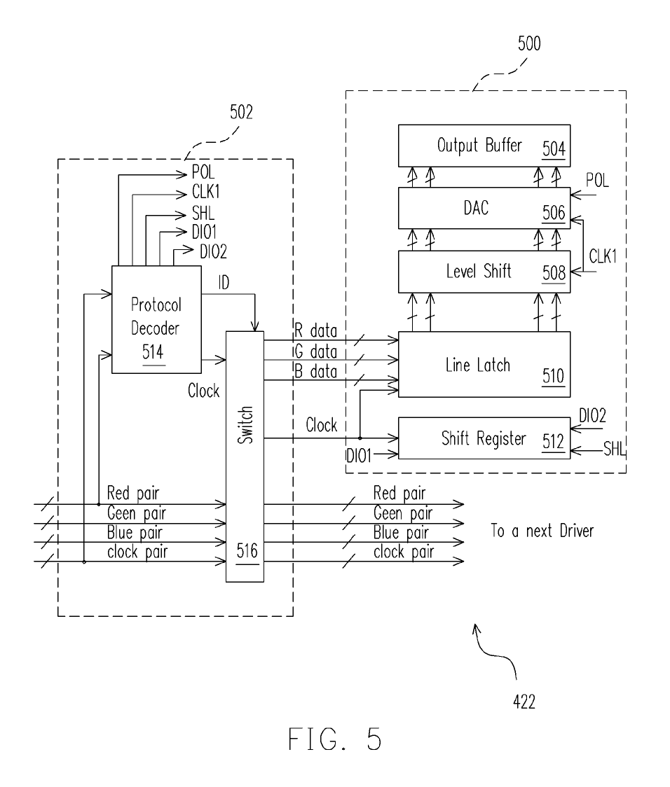

In preferred embodiment as shown in FIG. 5, the source driver 422 of the invention includes the state-in-the-art source driver 500, which can be the conventional source driver shown in FIG. 2, with the additional source input interface unit 502. The input interface unit 502 includes, for example, a serial-protocol decoder 514 and a switching unit 516. The interface unit 502 receives the image display signal from the VGA 430 and the timing signal clock. The image display signal includes, for example, R/G/B pair signals. The image display signal and the clock signal are continuously transmitted to the next driver via the switching unit 516. In addition, the image display signal and the clock signal are fed to the protocol decoder 514. The protocol decode 514 the decodes out several control signals, such as known POL, CLK1, . . . , and identification (ID) information or data head if they are necessary. The decoder 514 also decodes out the color information such as Red data, Green data, and Blue data, which are transmitted to the driver 500 via the switch unit 516. Here, the switch unit 516 has the function to pass the signals to the corresponding places and is not necessary to only behave the ON/OFF switching. In addition, the clock signal Clock is also fed to the driver 500, so as to allow the color information to be display at the proper time. In order to easily implement the features of the invention, the driver 500 can be conventional source driver, or the state-in-the-art source driver. The input interface unit 502, after decoding, produces the needed control signals and information to the driver 500.

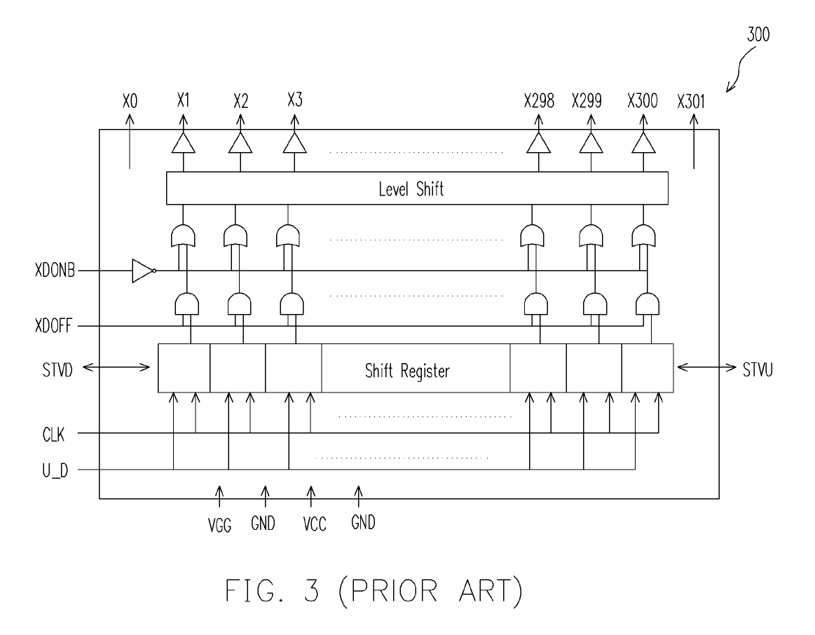

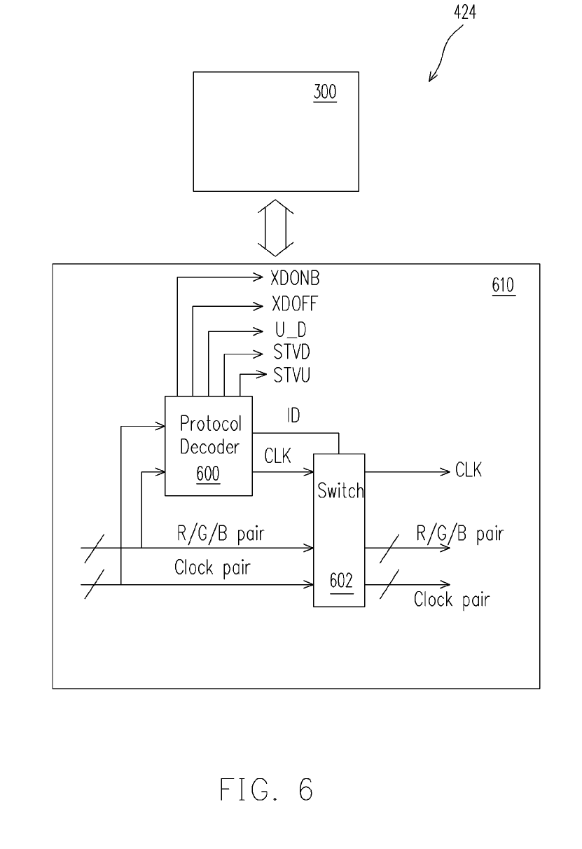

Likewise, the gate driver 424, as shown in FIG. 6, can also include the state-in-the-art gate driver 300 (see FIG. 3) and the gate input interface 610. The gate input interface unit 610 has the similar purpose to the source input interface unit 502, for decoding out the needed control signals. The gate driver 424 basically has different function from the source driver 500, and then the actual design is different. Therefore, the signals needed by the gate driver 300 can be encoded into one or more of the R/G/B pairs. The gate input interface 610 can receive a portion or the whole of the image display signal from the VGA 430, and the received signal is continuously passed to the next driver 610 via the switch unit 602. In addition, the received image display signals are also fed to the protocol decoder 600, used by the gate driver. As a result, the signals are decoded out for use in the conventional gate driver 300.

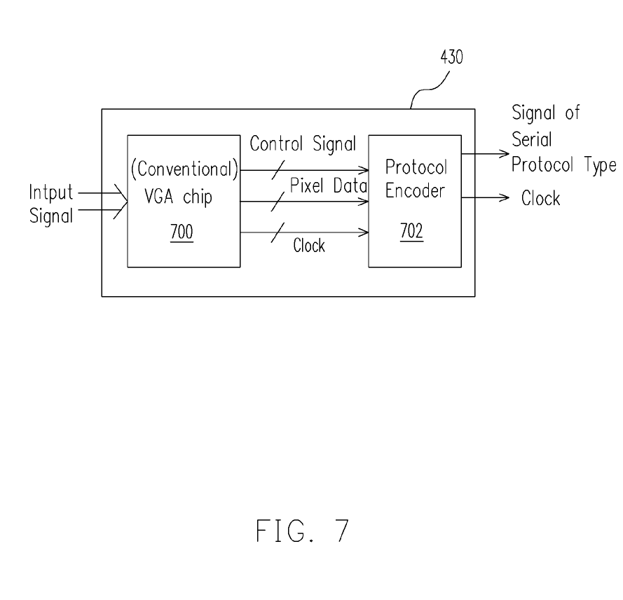

In order to have the signals to be transmitted in a serial protocol, and also be compatible with the conventional design, the VGA 430 can also be accordingly modified as shown in FIG. 7.

In FIG. 7, the VGA 430 of the invention includes, for example, a state-in-the-art VGA chip, such as the convention VGA 700, which produces the control signals, pixel data signals, clock signal Clock, and so on after the input is received. These signals are fed to a protocol encoder 702. The protocol encoder 702 encodes the signals into a serial-protocol signal. The serial-protocol signal and the clock are exported, as shown in FIG. 4, and are fed to the driver via the connector 428.

The invention particularly proposes the signal transmission by the serial-protocol format, and the drivers can respectively decode out the needed signals. The conventional ASIC chip can at least be omitted.

In addition, for the operation method, the invention provides a serial-protocol type panel display method. After an image display signal and a clock signal are received, the display signals are encoded into a serial-protocol image display signal, according the serial protocol. Then, the serial-protocol image display signal and the clock signal are sequentially fed to multiple first drivers, such as source drivers, and at least a portion of the serial-protocol image display signal and the clock signal are sequentially fed to multiple second drivers, such as the gate drivers. Each of the first gate drivers decodes the serial-protocol image display signal to have a first set of control signals and a plurality of color information used for pixel display. Each of the second drivers decodes the serial-protocol image display signal to have a second set of control signals. Also and, the first set of control signals, the second set of control signals, and the color information are used to accordingly drive the pixels.

It will be apparent to those skilled in the art that various modifications and variations can be made to the structure of the present invention without departing from the scope or spirit of the invention. In view of the foregoing descriptions, it is intended that the present invention cover modifications and variations of this invention if they fall within the scope of the following claims and their equivalents.

1. A serial-protocol panel display system, suitable for use in a panel display apparatus, comprising:
a pixel-array unit;
a plurality of drivers, used for driving the pixel-array unit to display image; and
a video graphic adapter (VGA) unit, according to a serial protocol, to export a serial-protocol image display signal and a clock signal to a corresponding one of the drivers, wherein the drivers decode the serial-protocol image display signal, so as to obtain a plurality of input signals, and to drive pixels of the pixel-array unit.

2. The serial-protocol panel display system of claim 1, further comprising a connector, coupled between the VGA unit and the drivers.

3. The serial-protocol panel display system of claim 1, further comprising a gamma correction unit, to provide color management information to a portion of the drives.

4. The serial-protocol panel display system of claim 1, further comprising a power source unit, to provide a plurality of voltage levels for use in the panel display system.

5. The serial-protocol panel display system of claim 1, wherein the drivers include source drivers and gate drivers.

6. The serial-protocol panel display system of claim 5, each of the source drivers includes:
a source input interface, receiving the serial-protocol image display signal exported from the VGA unit and the clock signal, wherein the serial-protocol image display signal and the clock signal are continuously transmitted to a next one of the source drivers, and are used for decoding out a plurality of source input signals in the input signals; and
a state-in-the-art source driver, respectively receiving the source input signals.

7. The serial-protocol panel display system of claim 6, wherein the source input interface comprises:
a decoding unit, according to the serial-protocol image display signal and the clock signal, decoding into the source input signals and exporting to the state-in-the-art source driver; and
a switch unit, passing the serial-protocol image display signal and the clock signal to the next one of the source drivers, and coupled with the decoding unit for exporting a decoded color information and the clock signal to the state-in-the-art source driver.

8. The serial-protocol panel display system of claim 6, wherein the serial-protocol image display signal includes color signals of red, green, and blue.

9. The serial-protocol panel display system of claim 5, wherein each of the gate drivers includes:
a gate input interface, receiving at least a portion of the serial-protocol image display signal exported from the VGA unit and the clock signal, wherein the serial-protocol image display signal and the clock signal are continuously transmitted to a next one of the gate drivers, and are used for decoding out a plurality of gate input signals in the input signals; and
a state-in-the-art gate driver, respectively receiving the gate input signals.

10. The serial-protocol panel display system of claim 9, wherein the serial-protocol image display signal includes color signals of red, green, and blue.

11. The serial-protocol panel display system of claim 10, wherein the gate input interface includes:
a decoding unit, according to the serial-protocol image display signal and the clock signal, decoding into the gate input signals and exporting to the state-in-the-art gate driver; and
a switch unit, passing the serial-protocol image display signal and the clock signal to the next one of the gate drivers, and coupled with the decoding unit for exporting a clock signal to the state-in-the-art gate driver.

12. The serial-protocol panel display system of claim 1, wherein the VGA unit includes:
a VGA chip; and
a protocol encoder, coupled with the VGA chip for encoding, and exporting the serial-protocol image display signal and clock signal.

13. A source driver, suitable for use in a panel display apparatus to drive corresponding pixels, comprising:
a source input interface, receiving a serial-protocol image display signal and a clock signal, wherein the serial-protocol image display signal and the clock signal are continuously transmitted to a next one of the source driver, and are used for decoding out a plurality of source input signals; and
a state-in-the-art source driver, respectively receiving the source input signals.

14. The source driver of claim 13, wherein the source input interface includes:
a decoding unit, according to the serial-protocol image display signal and the clock signal, decoding into the source input signals and exporting to the state-in-the-art source driver; and
a switch unit, passing the serial-protocol image display signal and the clock signal to the next one of the source driver, and coupled with the decoding unit for exporting a decoded color information and the clock signal to the state-in-the-art source driver.

15. A gate driver, suitable for use in a panel display apparatus to drive corresponding pixels, comprising:
a gate input interface, receiving a serial-protocol image display signal and a clock signal, wherein the serial-protocol image display signal and the clock signal are continuously transmitted to a next one of the gate driver, and are used for decoding out a plurality of gate input signals; and
a state-in-the-art gate driver, respectively receiving the gate input signals.

16. The gate driver of claim 15, wherein the gate input interface includes:
a decoding unit, according to the serial-protocol image display signal and the clock signal, decoding into the gate input signals and exporting to the state-in-the-art source driver; and
a switch unit, passing the serial-protocol image display signal and the clock signal to the next one of the gate driver, and coupled with the decoding unit for exporting the clock signal to the state-in-the-art gate driver.

17. A video graphic adapter (VGA), suitable for use in a panel display apparatus to receive image control signals, comprising:
a VGA chip, for receiving an image control signal; and
a protocol decoder, coupled with the VGA chip for encoding, and exporting a serial-protocol image display signal and a clock signal.

18. A serial-protocol panel display method, comprising:
receiving an image control signal and a clock signal;
encoding the image control signal into a serial-protocol image display signal, according to a serial protocol;
sequentially transmitting the serial-protocol image display signal and the clock signal to a plurality of first drivers;
sequentially transmitting at least a portion of the serial-protocol image display signal and the clock signal to a plurality of second drivers;
decoding the serial-protocol image display signal into a first set of control signals and a color information in each of the first drivers, used for pixel display;
decoding the serial-protocol image display signal into a second set of control signals in each of the second drivers; and
driving the corresponding pixels, according to the first set of control signals, the second set of control signal, and the color information.
